(19) United States
(12) Patent Application Publication
(10) Pub. No.: US 2026/0244245 A1
(43) Pub. Date: Aug. 20, 2026

(54) DOCKING STATION

(71) Applicant: ASMedia Technology Inc., New Taipei City (TW)

(72) Inventor: Chun-Jung Hsu, New Taipei City (TW)

(73) Assignee: ASMedia Technology Inc., New Taipei City (TW)

(21) Appl. No.: 19/079,438

(22) Filed: Mar. 13, 2025

(30) Foreign Application Priority Data
Feb. 20, 2025 (TW) 114106226

(51) Int. Cl. G06F 1/16; G06F 13/38; G06F 13/40; G06F 13/42

(52) U.S. Cl. CPC G06F 1/1632; G06F 13/382; G06F 13/4027; G06F 13/4282; G06F 2213/0042

(57) ABSTRACT

A docking station is provided. The docking station includes a first interface circuit and multiple artificial intelligence (AI) computing modules. The first interface circuit includes a first upstream facing port (UFP) and multiple first downstream facing ports (DFP). The first UFP is coupled to a host integrated circuit (IC) in a host. The first AI computing modules are coupled to the first DFPs to form an AI accelerator cluster. As such, the docking station is capable of increasing a computing efficiency of the host.

### CROSS-REFERENCE TO RELATED APPLICATION

This application claims the priority benefit of Taiwan application serial no. 114106226, filed on Feb. 20, 2025. The entirety of the above-mentioned patent application is hereby incorporated by reference herein and made a part of this specification.

### BACKGROUND

### Technical Field

The disclosure relates to a docking station, and in particular relates to a docking station adapted to be coupled to a host.

### Description of Related Art

As technology advances, the application of artificial intelligence (AI) has become increasingly prevalent. In order to accommodate the demand for extensive computational requirements, a host may be equipped with accelerators in addition to the central processing unit (CPU), such as a graphics processing unit (GPU). However, the current host cannot be connected to additional accelerators or computing modules, so that the computing performance of the host is low.

### SUMMARY

A docking station that may expand the computing modules externally connected to a host to form an AI accelerator cluster is provided in an embodiment of the disclosure, thereby improving the computing performance of the host.

The docking station according to the embodiment of the disclosure is adapted to be coupled to a host. The docking station includes a first interface circuit and multiple first artificial intelligence (AI) computing modules. The first interface circuit includes a first upstream facing port and multiple first downstream facing ports. The first upstream facing port is configured to couple to a host integrated circuit in a host. The first AI computing modules are configured to couple to the first downstream facing ports to form an AI accelerator cluster.

Based on the above, the docking station of the embodiment of the disclosure is coupled between the host integrated circuit and multiple AI computing modules through the first interface circuit, so that these AI computing modules and the host integrated circuit may cooperate to realize cluster computing. In this way, the docking station may expand the accelerator used in the host integrated circuit to improve the computing performance of the host.

In order to make the above-mentioned features and advantages of the disclosure comprehensible, embodiments accompanied with drawings are described in detail below.

### BRIEF DESCRIPTION OF THE DRAWINGS

FIG. 1 is a circuit block diagram of a docking station according to an embodiment of the disclosure.

FIG. 2A is a circuit block diagram of a docking station according to another embodiment of the disclosure.

FIG. 2B is a circuit block diagram of a docking station according to another embodiment of the disclosure.

FIG. 3A is a circuit block diagram of a docking station according to another embodiment of the disclosure.

FIG. 3B is a circuit block diagram of a docking station according to another embodiment of the disclosure.

### DETAILED DESCRIPTION OF DISCLOSED EMBODIMENTS

A portion of the embodiments of the disclosure will be described in detail with reference to the accompanying drawings. Element symbol referenced in the following description will be regarded as the same or similar element when the same element symbol appears in different drawings. These examples are only a portion of the disclosure and do not disclose all possible embodiments of the disclosure. More precisely, these embodiments are only examples within the scope of the patent application of the disclosure.

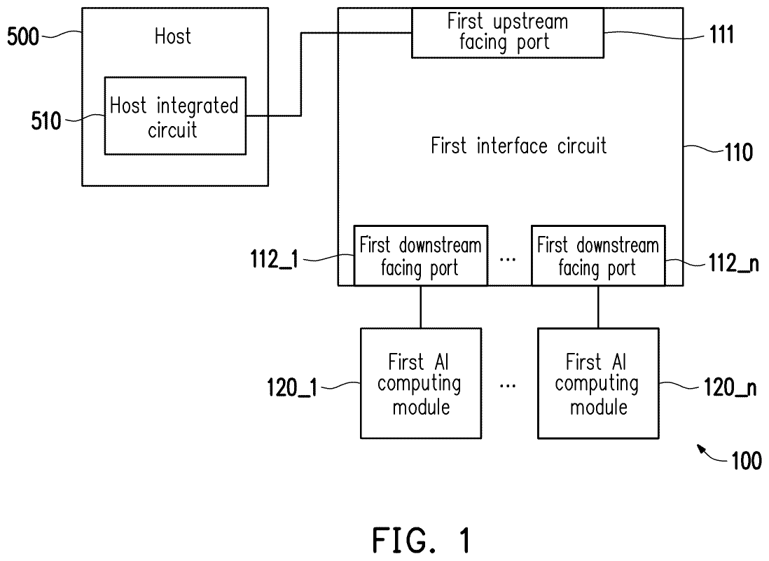

FIG. 1 is a circuit block diagram of a docking station according to an embodiment of the disclosure. Referring to FIG. 1, the docking station 100 is adapted to be coupled to a host 500, and more particularly to be coupled to a host integrated circuit 510 disposed on a motherboard of the host 500. The docking station 100 is used to expand the functions of the host integrated circuit 510, such as the computing functions used by artificial intelligence (AI).

In this embodiment, the host 500 may be included in electronic devices such as a mobile phone, a computer device, a tablet, a laptop, and a desktop computer. In this embodiment, the host integrated circuit 510 may be, for example, a field programmable gate array (FPGA), a central processing unit (CPU), or other programmable general-purpose or special-purpose microprocessor, a digital signal processor (DSP), a programmable controller, an application specific integrated circuit (ASIC), a programmable logic device (PLD) or other similar devices or a combination of the devices thereof, which may load and execute computer program-related firmware or software to realize various computing functions.

In the embodiment of FIG. 1, the docking station 100 includes a first interface circuit 110 and multiple first AI computing modules 120_1 to 120_n, where n is a positive integer greater than 1. The first interface circuit 110 may serve as a hub to couple the host integrated circuit 510 and the first AI computing modules 120_1 to 120_n together.

Specifically, the first interface circuit 110 includes a first upstream facing port (UFP) 111 and multiple first downstream facing ports (DFP) 112_1 to 112_n. The first upstream facing port 111 is configured to couple to the host integrated circuit 510. The first downstream facing ports 112_1 to 112_n are configured to couple to the first AI computing modules 120_1 to 120_n.

In this embodiment, each of the first AI computing modules 120_1 to 120_n is configured to execute an AI model. These first AI computing modules 120_1 to 120_n may be, for example, integrated circuits including AI accelerators, and may have the same circuit architecture. The AI model may be, for example, a deep neural network (DNN) model, a convolutional neural network (CNN) model, or other neural network models that apply machine learning.

In the application of expanding the AI computing function, the first AI computing modules 120_1 to 120_n form an AI accelerator cluster. The first AI computing modules 120_1 to 120_n cooperate with the host integrated circuit 510 to perform distributed computing to realize various functions used by AI.

It is worth mentioning that the first interface circuit 110 is used as a hub to enable the host integrated circuit 510 to be externally connected to multiple additional accelerators (e.g., the first AI computing modules 120_1 to 120_n). These first AI computing modules 120_1 to 120_n may form an AI accelerator cluster. In this way, the docking station 100 may expand the AI computing function of the host integrated circuit 510, thereby improving the computing performance of the host integrated circuit 510.

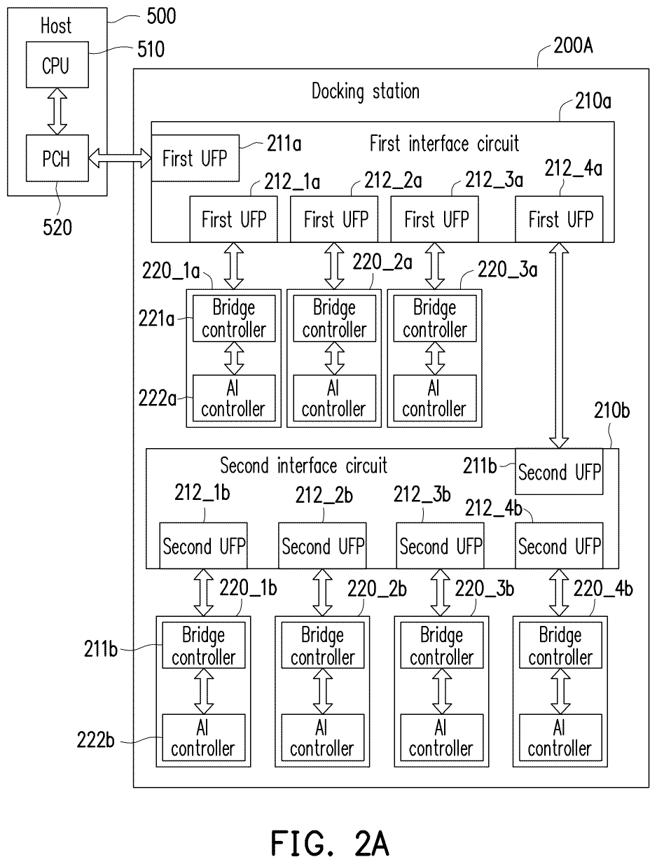

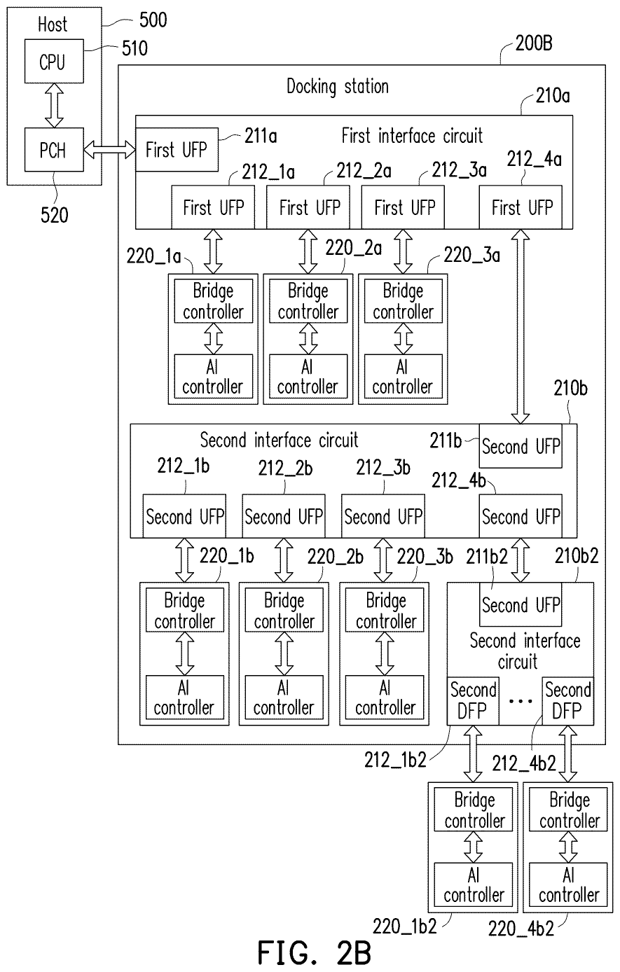

FIG. 2A is a circuit block diagram of a docking station according to another embodiment of the disclosure. Referring to 2A, the docking station 200A may be, for example, a docking station that implements the universal serial bus (USB) specification. Based on the USB specification, the docking station 200A is adapted to expand the AI computing function of the host integrated circuit 510 in the host 500. In this embodiment, the host 500 further includes a platform controller hub (PCH) 520. The platform controller hub 520 is coupled to the host integrated circuit 510.

In the embodiment of FIG. 2A, the docking station 200A includes a first interface circuit 210a and multiple first AI computing modules 220_1a to 220_3a. The first interface circuit 210a includes a first upstream facing port 211a and multiple first downstream facing ports 212_1a to 212_4a. For the first interface circuit 210a, the multiple components therein, and the multiple first AI computing modules 220_1a to 220_3a, reference may be made to the relevant description of the docking station 100 and be deduced by analogy. The numbers of the first AI computing modules 220_1a to 220_3a and the first downstream facing ports 212_1a to 212_4a are solely exemplary and illustrative.

In this embodiment, the first interface circuit 210a is configured to couple to the platform controller hub 520 through the first upstream facing port 211a based on the USB specification, and subsequently configured to couple to the host integrated circuit 510 through the platform controller hub 520. The first interface circuit 210a may be, for example, a USB hub compatible with USB specification such as USB2, USB3, and USB4.

In this embodiment, the first AI computing modules 220_1a to 220_3a are configured to respectively couple to the first downstream facing ports 212_1a to 212_3a based on the USB specification. That is, these first AI computing modules 220_1a to 220_3a communicate with the host integrated circuit 510 and transmit various data and/or signals through the first interface circuit 210a based on the USB specification.

In detail, the first AI computing modules 220_1a to 220_3a have the same circuit architecture. Taking the first AI computing module 220_1a as an example, the first AI computing module 220_1a includes a bridge controller 221a and an AI controller 222a. The bridge controller 221a is coupled to the AI controller 222a. The bridge controller 221a is also coupled to a corresponding one of the first downstream facing ports (i.e., the first downstream facing port 212_1a) based on the USB specification. In this embodiment, the bridge controller 221a may be, for example, a USB bridge controller, so as to bridge the first interface circuit 210a and the corresponding AI controller 222a based on the USB specification.

It should be noted that the docking station 200A may determine the number of the first AI computing modules 220_1a to 220_3a according to the requirements of the AI computing function and/or cost considerations. In this way, the docking station 200A may flexibly adjust (i.e., expand or reduce) the AI accelerator cluster externally connected to the host integrated circuit 510.

In addition, the first interface circuit 210a may realize plug-and-play of any one of the first AI computing module 220_1a to 220_3a based on the USB specification. In this way, the docking station 200A has high usage flexibility.

In this embodiment, the docking station 200A further includes at least one second interface circuit 210b and multiple second AI computing modules 220_1b to 220_4b, in which the number of the second AI computing modules 220_1b to 220_4b is solely exemplary and illustrative. The second interface circuit 210b may serve as a hub to couple the first interface circuit 210a and the second AI computing modules 220_1b to 220_4b together.

Specifically, the second interface circuit 210b includes a second upstream facing port 211b and multiple second downstream facing ports 212_1b to 212_4b. The second upstream facing port 211b is configured to couple to one of the first downstream facing ports (e.g., the first downstream facing port 212_4a) of the first interface circuit 210a. The second downstream facing ports 212_1b to 212_4b are configured to couple to the second AI computing modules 220_1b to 220_4b.

In the application of expanding the AI computing function, since the host 500 is externally connected to multiple first AI computing modules 220_1a to 220_3a through the first interface circuit 210a, and is also externally connected to multiple second AI computing modules 220_1b to 220_4b through the second interface circuit 210b, the first AI computing modules 220_1a to 220_3a and the second AI computing modules 220_1b to 220_4b form an AI accelerator cluster. Thus, the AI computing modules 220_1a to 220_3a and 220_1b to 220_4b cooperate with the host integrated circuit 510 to perform distributed computing to realize various functions used by AI.

In this embodiment, the second interface circuit 210b is configured to couple to the first downstream facing port 212_4a of the first interface circuit 210a through the second upstream facing port 211b based on the USB specification. The second interface circuit 210b may be, for example, a USB hub compatible with USB specification such as USB2, USB3, and USB4.

In this embodiment, the second AI computing modules 220_1b to 220_4b are configured to respectively couple to the second downstream facing ports 212_1b to 212_4b based on the USB specification. That is, these second AI computing modules 220_1b to 220_4b communicate with the host integrated circuit 510 and transmit various data and/or signals through the second interface circuit 210b and the first interface circuit 210a based on the USB specification.

In detail, the plurality of second AI computing modules 220_1b to 220_4b have the same circuit architecture. Taking the second AI computing module 220_1b as an example, the second AI computing module 220_1b includes a bridge controller 221b and an AI controller 222b. The bridge controller 221b is coupled to the AI controller 222b. The bridge controller 221a is also coupled to a corresponding one of the second downstream facing ports (i.e., the second downstream facing port 212_1b) based on the USB specification. In this embodiment, the bridge controller 221b may be, for example, a USB bridge controller, so as to bridge the second interface circuit 210b and the corresponding AI controller 222b based on the USB specification.

It should be noted that the docking station 200A may determine the number of the second interface circuits 210b and the number of AI computing modules 220_1a to 220_3a and 220_1b to 220_4b according to the requirements of the AI computing function and/or cost considerations. In this way, the docking station 200A may flexibly adjust the computing performance of the host integrated circuit 510.

Referring to FIG. 2B, FIG. 2B is a circuit block diagram of a docking station according to another embodiment of the disclosure. Compared to the embodiment of FIG. 2A, in the embodiment of FIG. 2B, the docking station 200B further includes another second interface circuit 210b2. That is, there are multiple second interface circuits, and two second interface circuits 210b and 210b2 are taken as examples for description.

In this embodiment, the second interface circuit 210b2 includes a second upstream facing port 211b2 and multiple second downstream facing ports 212_1b2 to 212_4b2. The second upstream facing port 211b2 is configured to couple to one of the second downstream facing ports (e.g., the second downstream facing port 212_4b) of the second interface circuit 210b. The second downstream facing ports 212_1b2 to 212_4b2 are configured to couple to the second AI computing modules 220_1b2 to 220_4b2.

In addition, the second interface circuits 210b and 210b2 are configured to be serially connected together in sequence through their respective second upstream facing ports 211b and 211b2 and one of their respective second downstream facing ports (e.g., the second downstream facing ports 212_4b and 212_4b2), and are also configured to be serially connected to one of the first downstream facing ports (e.g., the first downstream facing port 212_4a) of the first interface circuit 210a.

Thus, compared to the embodiment of FIG. 2A, in this embodiment, the host integrated circuit 510 may be further externally connected to more AI computing modules (including second AI computing modules 220_1b2 to 220_4b2) through the second interface circuits 210b and 210b2. Therefore, the docking station 200B may expand the AI accelerator cluster externally connected to the host integrated circuit 510 (i.e., the cluster formed by the AI computing modules 220_1a to 220_3a, 220_1b to 220_3b, and 220_1b2 to 220_4b2).

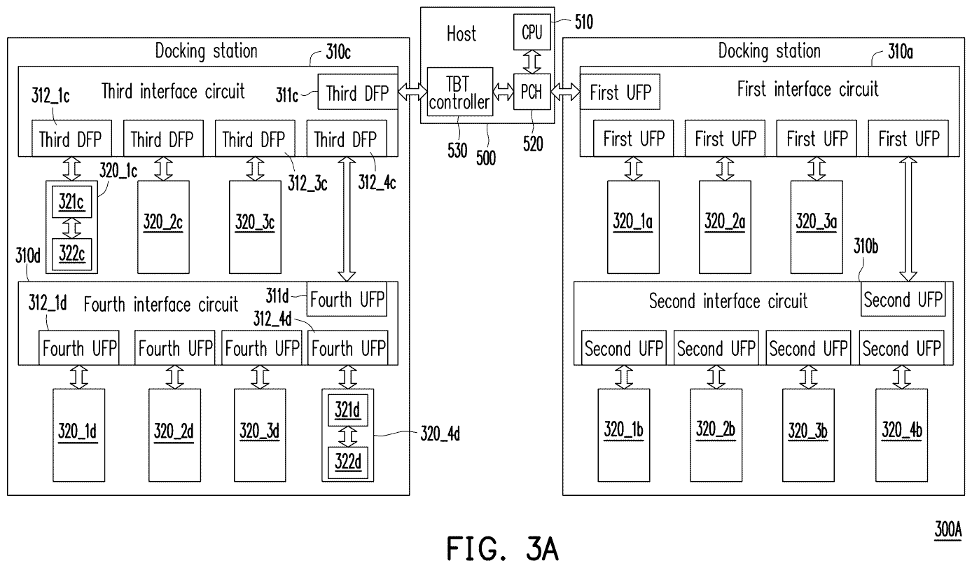

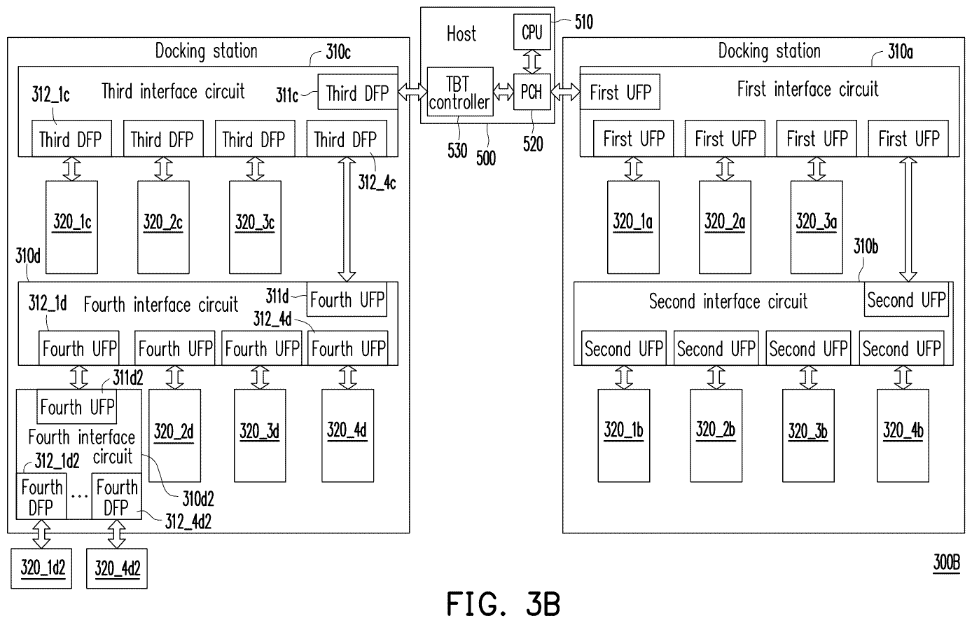

FIG. 3A is a circuit block diagram of a docking station according to another embodiment of the disclosure. Referring to 3A, the docking station 300A may be, for example, a docking station that implements the USB specification and the Thunderbolt (TBT) specification. Based on the USB and/or TBT specifications, the docking station 300A is adapted to expand the AI computing function of the host integrated circuit 510 in the host 500. In this embodiment, the host 500 further includes a TBT controller 530. The TBT controller 530 is coupled to the host integrated circuit 510.

In the embodiment of FIG. 3A, the docking station 300A includes a first interface circuit 310a, multiple first AI computing modules 320_1a to 320_3a, a second interface circuit 310b, and multiple second AI computing modules 320_1b to 320_4b. For the first interface circuit 310a, the second interface circuit 310b, and the AI computing modules 320_1a to 320_3a and 320_1b to 320_4b, reference may be made to the relevant description of the docking station 200A and be deduced by analogy.

Compared to the embodiment of FIG. 2A, in the embodiment of FIG. 3A, the docking station 300A further includes a third interface circuit 310c and multiple third AI computing modules 320_1c to 320_3c, in which the number of these computing modules 320_1c to 320_3c is solely exemplary and illustrative. The third interface circuit 310c may serve as a hub to couple the host integrated circuit 510 and the third AI computing modules 320_1c to 320_3c together.

Specifically, the third interface circuit 310c includes a third upstream facing port 311c and multiple third downstream facing ports 312_1c to 312_4c. The third upstream facing port 311c is configured to couple to the host integrated circuit 510. The third downstream facing ports 312_1c to 312_4c are configured to couple to the third AI computing modules 320_1c to 320_3c.

In the application of expanding the AI computing function, the host 500 is externally connected to multiple AI computing modules through multiple interface circuits 310a, 310b and 310c to expand the AI computing function. That is, the first AI computing modules 320_1a to 320_3a, the second AI computing modules 320_1b to 320_4b, and the third AI computing modules 320_1c to 320_3c form an AI accelerator cluster to cooperate with the host integrated circuit 510 to realize various functions used by AI.

It should be noted that the first upstream facing port 311a of the first interface circuit 310 and the third upstream facing port 311c of the third interface circuit 310c are respectively coupled to the host integrated circuit 510 based on different transmission specification (e.g., USB specification and TBT specification).

Specifically, the first interface circuit 310a is configured to couple to the platform controller hub 520 through the first upstream facing port 311a based on the USB specification, and subsequently configured to couple to the host integrated circuit 510 through the platform controller hub 520. The third interface circuit 310c is configured to couple to the TBT controller 530 through the third upstream facing port 311c based on the TBT specification, and subsequently configured to couple to the host integrated circuit 510 through the TBT controller 530. The third interface circuit 310c may be, for example, a TBT hub compatible with TBT specifications such as TBT3, TBT4, and TBT5.

In this embodiment, the third AI computing modules 320_1c to 320_3c are configured to respectively couple to the third downstream facing ports 312_1c to 312_3c based on the TBT specification. That is, these third AI computing modules 320_1c to 320_3c communicate with the host integrated circuit 510 and transmit various data and/or signals through the third interface circuit 310c based on the TBT specification.

In detail, the third AI computing modules 320_1c to 320_3c have the same circuit architecture. Taking the third AI computing module 320_1c as an example, the third AI computing module 320_1c includes a bridge controller 321c and an AI controller 322c. The bridge controller 321c is coupled to the AI controller 322c. The bridge controller 221a is further coupled to a corresponding one of the third downstream facing ports (i.e., the third downstream facing port 312_1c) based on the TBT specification. In this embodiment, the bridge controller 321c may be, for example, a TBT accessory controller to bridge the third interface circuit 310c and the corresponding AI controller 222c based on the TBT specification.

It should be noted that the docking station 300A may determine the number of the AI computing modules 320_1a to 320_3a, 320_1b to 320_4b and 320_1c to 320_3c according to the requirements of AI computing functions and/or cost considerations. In this way, the docking station 200B may flexibly adjust (i.e., expand or reduce) the AI accelerator cluster externally connected to the host integrated circuit 510.

In addition, the third interface circuit 310c may be compatible with AI computing modules that implement the USB specification and realize plug-and-play of any one of the third AI computing module 320_1c to 320_3c based on the TBT specification. In this way, the docking station 200B has high usage flexibility.

In the embodiment of FIG. 3A, the docking station 300A may further include at least one fourth interface circuit 310d and multiple fourth AI computing modules 320_1d to 320_4d, in which the number of the fourth AI computing modules 320_1d to 320_4d is solely exemplary and illustrative. The fourth interface circuit 310d may serve as a hub to couple the third interface circuit 310c and the fourth AI computing modules 320_1d to 320_4d together.

Specifically, the fourth interface circuit 310d includes a fourth upstream facing port 311d and multiple fourth downstream facing ports 312_1d to 312_4d. The fourth upstream facing port 311d is configured to couple to one of the third downstream facing ports (e.g., the third downstream facing port 312_4c) of the third interface circuit 310c. The fourth downstream facing ports 312_1d to 312_4d are configured to couple to the fourth AI computing modules 320_1d to 320_4d.

In the application of expanding the AI computing function, the host 500 is externally connected to multiple AI computing modules through multiple interface circuits 310a, 310b, 310c and 310d to expand the AI computing function. That is, the first AI computing modules 320_1a to 320_3a, the second AI computing modules 320_1b to 320_4b, the third AI computing modules 320_1c to 320_3c, and the fourth AI computing modules 320_1d to 320_4d form an AI accelerator cluster to cooperate with the host integrated circuit 510 to realize various functions used by AI.

In this embodiment, the fourth interface circuit 310d is configured to couple to the third downstream facing port 312_4c of the third interface circuit 310c through the fourth upstream facing port 311d based on the TBT specification. The fourth interface circuit 310d may be, for example, a TBT hub compatible with TBT specification such as TBT3, TBT4, and TBT5.

In this embodiment, the fourth AI computing modules 320_1d to 320_4d are configured to respectively couple to the fourth downstream facing ports 312_1d to 312_4d based on the TBT specification. That is, these fourth AI computing modules 320_1d to 320_4d communicate with the host integrated circuit 510 and transmit various data and/or signals through the fourth interface circuit 310d and the third interface circuit 310c based on the TBT specification.

In detail, the fourth AI computing modules 320_1d to 320_4d have the same circuit architecture. Taking the fourth AI computing module 320_4d as an example, the fourth AI computing module 320_4d includes a bridge controller 321d and an AI controller 322d. The bridge controller 321d is coupled to the AI controller 322d. The bridge controller 321d is further coupled to a corresponding one of the fourth downstream facing ports (i.e., the fourth downstream facing port 312_4d) based on the TBT specification. In this embodiment, the bridge controller 321d may be, for example, a TBT bridge controller, so as to bridge the fourth interface circuit 310d and the corresponding AI controller 322d based on the TBT specification.

It should be noted that the docking station 300A may determine the number of the fourth interface circuit 310d and the number of AI computing modules 320_1a to 320_3a, 320_1b to 320_4b, 320_1c to 320_3c and 320_1d to 320_4d according to the requirements of the AI computing function and/or cost considerations. In this way, the docking station 300A may flexibly adjust the computing performance of the host integrated circuit 510.

Referring to FIG. 3B, FIG. 3B is a circuit block diagram of a docking station according to another embodiment of the disclosure. Compared to the embodiment of FIG. 3A, in the embodiment of FIG. 3B, the docking station 300B further includes another fourth interface circuit 310d2. That is, there are multiple fourth interface circuits, and two fourth interface circuits 310d and 310d2 are taken as examples for description.

In this embodiment, the fourth interface circuit 310d2 includes a fourth upstream facing port 311d2 and multiple fourth downstream facing ports 312_1d2 to 312_4d2. The fourth upstream facing port 311d2 is configured to couple to one of the fourth downstream facing ports (e.g., the fourth downstream facing port 312_1d) of the fourth interface circuit 310d. The fourth downstream facing ports 312_1d2 to 312_4d2 are configured to couple the fourth AI computing modules 420_1d2 to 420_4d2.

In addition, the fourth interface circuits 310d and 310d2 are configured to be serially connected together in sequence through their respective fourth upstream facing ports 311d and 311d2 and one of their respective fourth downstream facing ports (e.g., the fourth downstream facing ports 312_1d and 312_1d2), and are also configured to be serially connected to one of the third downstream facing ports (e.g., the third downstream facing port 312_4c) of the third interface circuit 310c.

Thus, compared to the embodiment of FIG. 3A, in this embodiment, the host integrated circuit 510 may be further externally connected to more AI computing modules (including fourth AI computing modules 320_1d to 320_3d and 320_1d2 to 320_4d2) through the fourth interface circuits 310d and 310d2. Therefore, the docking station 300B may expand the AI accelerator cluster externally connected to the host integrated circuit 510 (i.e., the cluster formed by the AI computing modules 220_1a to 220_3a, 220_1b to 220_4b, 320_1c to 320_3c, 320_1d to 320_3d and 320_1d2 to 320_4d2).

In summary, the docking station of the embodiment of the disclosure is externally connected to multiple AI computing modules through at least one interface circuit as a hub, and may expand the AI computing function of the host according to the AI accelerator cluster formed by these AI computing modules. In this way, the docking station may improve the computing performance of the host, thereby improving the performance of AI applications. In some embodiments, the docking station may realize plug-and-play of any AI computing module and has high usage flexibility through the USB or TBT specification supported by the interface circuit. In some embodiments, since the docking station may determine the number of interface circuits and AI computing modules, the docking station may flexibly adjust the computing performance of the host integrated circuit.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A docking station, adapted to be coupled to a host, comprising:
a first interface circuit, comprising a first upstream facing port and a plurality of first downstream facing ports, wherein the first upstream facing port is configured to couple to a host integrated circuit in a host; and
a plurality of first artificial intelligence (AI) computing modules, configured to couple to the first downstream facing ports to form an AI accelerator cluster.

2. The docking station according to claim 1, wherein the first interface circuit is configured to couple to the host integrated circuit through the first upstream facing port and a platform interface hub in the host based on a universal serial bus (USB) specification.

3. The docking station according to claim 2, wherein the first AI computing modules are configured to couple to the first downstream facing ports based on the USB specification.

4. The docking station according to claim 3, wherein each of the first AI computing modules comprises:
a bridge controller, coupled to a corresponding one of the first downstream facing ports based on the USB specification; and
an AI controller, coupled to the bridge controller.

5. The docking station according to claim 1, further comprising:
at least one second interface circuit, comprising a second upstream facing port and a plurality of second downstream facing ports, wherein the second upstream facing port is configured to couple to one of the first downstream facing ports; and
a plurality of second AI computing modules, configured to couple to the second downstream facing ports, so that the first AI computing modules and the second AI computing modules form the AI accelerator cluster.

6. The docking station according to claim 5, wherein there are multiple of the at least one second interface circuit, the second interface circuits are configured to be serially connected to one of the first downstream facing ports in sequence through the respective second upstream facing port and the respective one of the second downstream facing ports.

7. The docking station according to claim 5, wherein the second AI computing modules are configured to couple to the second downstream facing ports based on a USB specification.

8. The docking station according to claim 7, wherein each of the second AI computing modules comprises:
a bridge controller, coupled to a corresponding one of the second downstream facing ports based on the USB specification; and
an AI controller, coupled to the bridge controller.

9. The docking station according to claim 5, further comprising:
a third interface circuit, comprising a third upstream facing port and a plurality of third downstream facing ports, wherein the first upstream facing port and the third upstream facing port are respectively coupled to the host integrated circuit based on different transmission specifications; and
a plurality of third AI computing modules, configured to couple to the third downstream facing ports, so that the first AI computing modules, the second AI computing modules, and the third AI computing modules form the AI accelerator cluster.

10. The docking station according to claim 9, wherein the first interface circuit is configured to couple to the host integrated circuit through the first upstream facing port and a platform interface controller in the host based on a USB specification,
wherein the third interface circuit is configured to couple to the host integrated circuit through the third upstream facing port and a Thunderbolt (TBT) controller in the host based on a TBT specification.

11. The docking station according to claim 10, wherein the third AI computing modules are configured to couple to the third downstream facing ports based on the TBT specification.

12. The docking station according to claim 11, wherein each of the third AI computing modules comprises:
a bridge controller, coupled to a corresponding one of the third downstream facing ports based on the TBT specification; and
an AI controller, coupled to the bridge controller.

13. The docking station according to claim 9, further comprising:
at least one fourth interface circuit, comprising a fourth upstream facing port and a plurality of fourth downstream facing ports, wherein the fourth upstream facing port is configured to couple to one of the third downstream facing ports; and
a plurality of fourth AI computing modules, configured to couple to the fourth downstream facing ports, so that the first AI computing modules, the second AI computing modules, the third AI computing modules and the fourth AI computing modules form the AI accelerator cluster.

14. The docking station according to claim 13, wherein there are multiple of the at least one fourth interface circuit, the fourth interface circuits are configured to be serially connected to one of the third downstream facing ports in sequence through the respective fourth upstream facing port and the respective one of the fourth downstream facing ports.

15. The docking station according to claim 13, wherein the fourth AI computing modules are configured to couple to the fourth downstream facing ports based on a TBT specification.

16. The docking station according to claim 15, wherein each of the fourth AI computing modules comprises:
a bridge controller, configured to couple to a corresponding one of the fourth downstream facing ports based on the TBT specification; and
an AI controller, coupled to the bridge controller.
